(19) United States
(12) Patent Application Publication
(10) Pub. No.: US 2006/0253729 A1
(43) Pub. Date: Nov. 9, 2006

(54) Outboard swap of defective device in a storage subsystem

(75) Inventor: Ralph T. Beeston, Tucson, AZ (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/121,209

(22) Filed: May 3, 2005

(51) Int. Cl. G06F 11/00

(52) U.S. Cl. 714/6

(57) ABSTRACT

A storage subsystem employs one or more device controllers for controlling a plurality of devices. At the request of a host, a device controller controls a writing of data from the host to device including a media mounted in a first drive. In response to a detection of a defect in the device, the device controller controls a swap of the first drive for the second drive, which includes the device controller recovering any first portion of the data buffered in the first drive and/or any second portion of the data recorded on the first media, and writing any recovered first portion of the data and/or any recovered second portion of the data to the second drive.

### FIELD OF INVENTION

The present invention generally relates to a control of a writing of data from a host to a device, which is a logical or physical view by the host of a drive and a controller function of that drive. The present invention specifically relates to controlling an execution of a drive swap or a media swap based on a detected defect in the device or media mounted in the drive of the device.

### BACKGROUND OF THE INVENTION

In a tape subsystem, there exists a possibility of a device becoming defective prior to or during a write of data from a host to a media mounted in a drive of the device. Currently, when the device becomes defective, a process for write recovery of any data written to the drive is initiated by the host where the host is required to recover data buffered in the device. Several drawbacks to this write recovery process as initiated by the host is that the host can be slow at recovering any buffered data, the size of a buffer of the device may make it difficult for the host to allocate internal space to hold any recovered buffer data, and moving the media to a new device will not be effective if the media is defective. A challenge therefore for the storage industry is to resolve the drawbacks of a host initiated write recovery process.

### SUMMARY OF THE INVENTION

One form of the present invention is a signal bearing medium tangibly embodying a program of machine-readable instructions executable by a processor to perform operations for controlling a writing of data from a host to a device including a media mounted in a first drive, and for controlling a swap of the first drive for a second drive in response to a detection of a defect in the device. The controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

A second form of the present invention is a device controller employing a processor and a memory storing instructions operable with the processor. The instructions are executed for controlling a writing of data from a host to a device including a media mounted in a first drive, and for controlling a swap of the first drive for a second drive in response to a detection of a defect. The controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

A third form of the present invention is a storage subsystem employing a plurality of drives, a plurality of media, and a device including a device controller operatively coupled to a first drive. The device controller controls a writing of data from a host to a media mounted in the first drive, and controls a swap of the first drive for a second drive in response to a detection of a defect in the device. The controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

The forgoing forms and other forms, objects, and aspects as well as features and advantages of the present invention will become further apparent from the following detailed description of the various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary removable media storage networking environment for practicing the present invention;

FIG. 2 illustrates a flowchart representative of one embodiment of a write control method in accordance with the present invention;

FIG. 3 illustrates a flowchart representative of one embodiment of a swap control method in accordance with the present invention; and

FIG. 4 illustrates one embodiment of a device controller in accordance with the present invention.

### DESCRIPTION OF THE PRESENT INVENTION

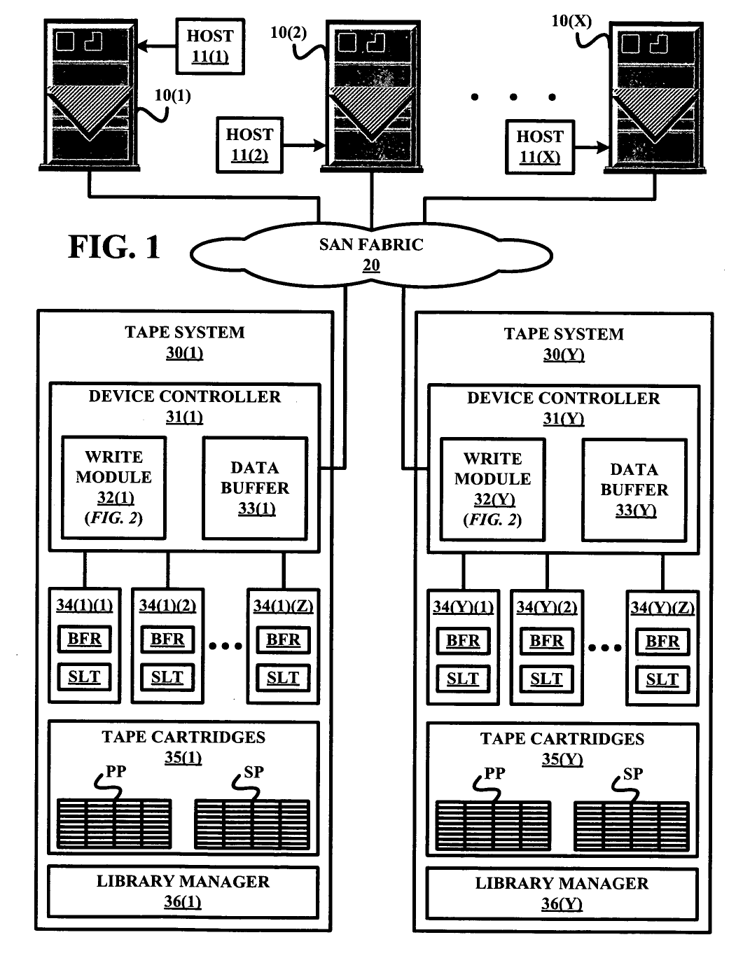

FIG. 1 illustrates an exemplary removable media storage networking environment for practicing the present invention. Referring to FIG. 1, an X number of servers 10 are physically connected via a storage area network (“SAN”) fabric 20 to a Y number of tape systems 30, where X≧1 and Y≧1. A host 11 is installed on each server 10 to perform a read of data stored on devices of tape systems 30 and a write of data to the devices of tape systems 30. To this end, each tape system 30 includes a device controller 31 and a Z number of drives 34, where Z≧2 and a logical device of tape system 30 consists of device controller 31 and one of the drives 34. In one exemplary embodiment, a majority portion of the drives 34 are allocated to logical devices while a minority portion of the drives 34 are allocated to a spare drive pool. Each logical device consists of the functionality of device controller 31 and one or more of the drives 34.

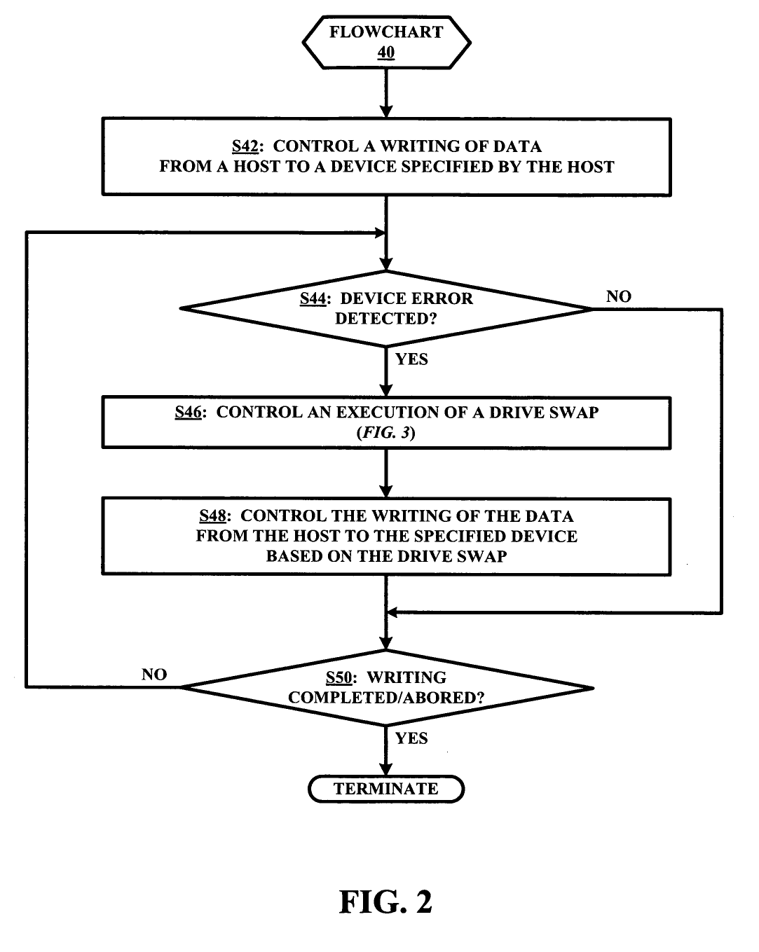

Each tape system 30 further employs a primary pool (“PP”) and a spare pool (“SP”) of tape cartridges 35, and a library manager 36 for managing tape cartridges 35. Each device controller 31 employs a write module 32 structurally configured with hardware, software and/or firmware to implement a write control method of the present invention as represented by a flowchart 40 illustrated in FIG. 2. To facilitate an understanding of the present invention, flowchart 40 will be described herein in the context of an execution of a write procedure between host 11(1) on server 10(1) and tape system 30(1).

Referring to FIG. 2, a stage S42 of flowchart 40 encompasses module 32(1) controlling a writing of data from a host 11(1) to a device specified by host 11(1) where tape drive 34(1)(1) is allocated to the device at the time of the write request from host 11(1). In one embodiment known in the art, module 32(1) directs library manager 36(1) to mount a specified tape cartridge 35(1)(1) of the primary pool in a slot (“SLT”) of tape drive 34(1)(1), where the tape cartridge 35(1)(1) is specified by a volume serial number or a storage location. Module 32(1) thereafter controls a writing of data from host 11(1) by temporarily storing data from host 11(1) in a data buffer 33(1) and then writing the buffered data from data buffer 33(1) to a buffer (“BFR”) of tape drive 34(1)(1). Stage S42 is ongoing until such time host 11(1) has completed or aborted the writing of data to the device, or module 32(1) detects a device error in stage S44 of flowchart 40 prior to host 11(1) completing or aborting the writing of data to the device. In an exemplary embodiment of stage S44, module 32(1) detects a device error based on a message from specified tape drive 34(1)(1) indicative of an actual drive error or an actual tape cartridge error or based on performance and usage data of specified tape drive 34(1)(1) or specified tape cartridge 35(1)(1) indicative of an actual/potential drive error or tape cartridge error as would be appreciated by those having ordinary skill in the art.

If module 32(1) detects a device error during stage S44 prior to host 11(1) completing or aborting the writing of data to the device, then module 32(1) proceeds to a stage S46 of flowchart 40 to control an execution of drive swap involving a replacement of specified tape drive 34(1)(1) with another one of the tape drives 34(1). In one exemplary embodiment of stage S46, a policy is utilized to select the replacement tape drive 34(1) from either a free tape drive 34(1) also allocated to the device at the time of the write request from host 11(1) (if any), a free tape drive 34(1) allocated to another device at the time of the write request from host 11(1) (if any), or a spare tape drive 34(1) (if any). The policy should be directed to selecting the replacement tape drive 34(1) in quickest and highest possible recovery possible based on the performance and usage data of the selectable tape drives 34 and in a manner transparent to the host as would be appreciated by those having ordinary skill in the art.

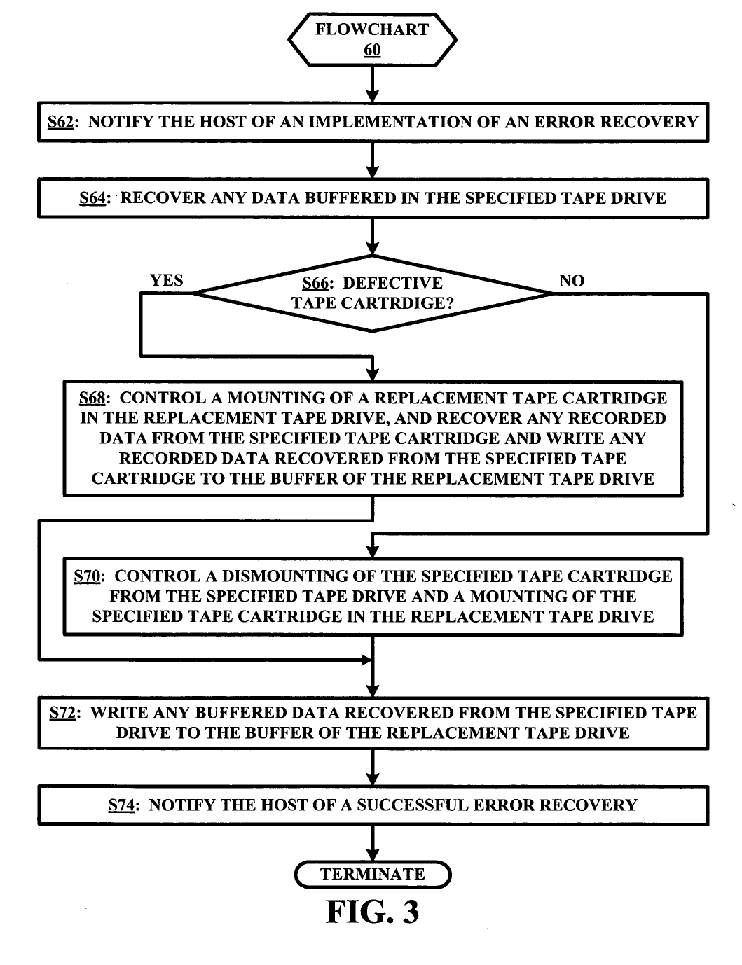

In practice, the present invention does not impose any limitations or any restrictions to the structural configuration of module 32(1) in performing stage S46. Thus, the following description of a flowchart 60 illustrated in FIG. 3 as one embodiment of stage S46 does not limit or restrict the scope of the structural configurations of module 32(1) in performing stage S46. To facilitate an understanding of flowchart 60, flowchart 60 will be described in the context of a tape drive 34(1)(2) being the replacement tape drive.

Referring to FIG. 3, a stage S62 of flowchart 60 encompasses module 32(1) notifying host 11(1) of an implementation of an error recovery in response to the detection of the device defect whereby host 11(1) can extend the time host 11(1) will wait for the present write operation to be completed by the device. Host 11(1) may decide to abort the present write operation prior to or upon the expiration of such time.

A stage S64 of flowchart 60 encompasses module 32(1) recovering any data buffered in specified tape drive 34(1)(1), and a stage S66 of flowchart 60 encompasses module 32(1) determining whether the specified tape cartridge 35(1)(1) is defective.

If the specified tape cartridge 35(1)(1) is defective, then module 32(1) proceeds to a stage S68 of flowchart 60 to direct library manager 36 (1) to mount a replacement tape cartridge 35(1)(2) in the replacement tape drive 34(1)(2) to thereby control a copying of any data recorded on the specified tape cartridge 35(1)(1) to the replacement tape cartridge 35(1)(2) by recovering any recorded data in the specified tape cartridge 35(1)(1) and writing any recorded data recovered from the specified tape cartridge 35(1)(1) to the buffer of the replacement tape drive 34(1)(2). To facilitate future reads of the data, library manager 36(1) will mark the specified tape cartridge 35(1)(1) as a failed media and give the replacement tape cartridge 35(1)(2) the identity of the specified tape cartridge 35(1)(1).

If the specified tape cartridge 35(1)(1) is not defective, then module 32(1) proceeds to a stage S70 of flowchart 60 to direct library 36(1) to dismount the specified tape cartridge 35(1)(1) from specified tape drive 34(1)(1) and to mount the specified tape cartridge 35(1)(1) in the replacement tape drive 34(1)(2) whereby module 32(1) points to the last recorded position in the specified tape cartridge 35(1)(1) to thereby facilitate a continuation of writing of the data to specified tape drive 34(1)(1).

Upon completion of stage S68 or stage S70, module 32(1) sequentially proceeds to a stage S72 of flowchart 70 to writing any buffered data recovered from the buffer of the specified tape drive 34(1)(1) to the buffer of the replacement tape drive 34(1)(2) whereby the recovered buffered data is stored in the buffer of the replacement tape drive 34(1)(2), and a stage S74 of flowchart 70 to notify host 11(1) of a successful error recovery.

Referring again to FIG. 2, a stage S48 of flowchart 40 encompasses module 32(1) controlling a writing of the data from host 11(1) to the specified device, which will transparently be the replacement tape drive 34(1)(2) having the specified tape cartridge 35(1)(1) or the replacement tape cartridge 35(1)(2) mounted therein. Stage S48 will continue until such time the writing is complete or aborted by host 11(1), or another device error is detected. In the latter case, stage S46 will be repeated whereby replacement tape drive 34(1)(2) will be swapped with another of the tape drives 34(1) and replacement tape cartridge 35(1)(2) may be swapped with another of the tape cartridges 35(1).

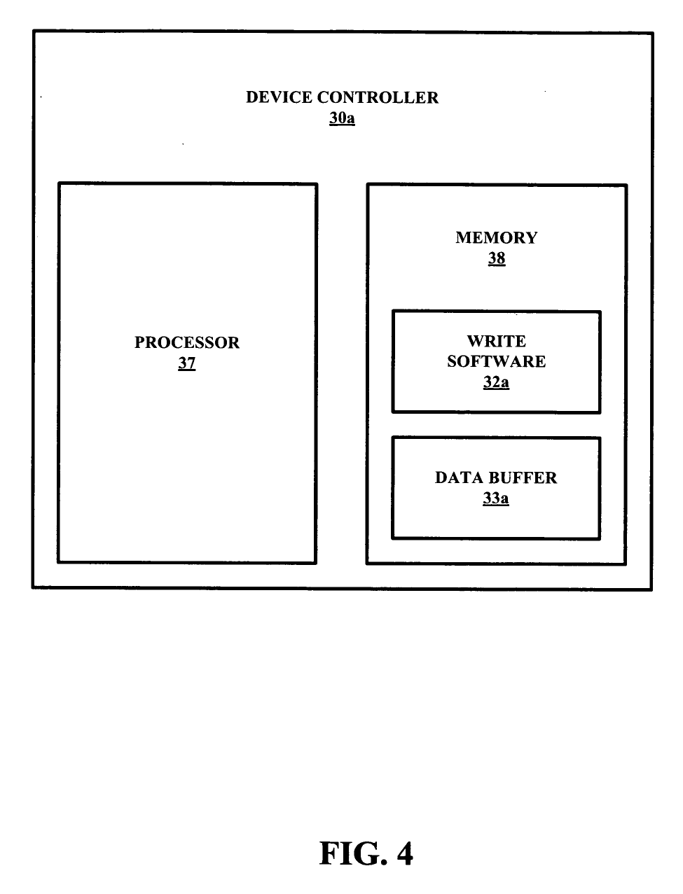

Referring to FIGS. 1 and 4, in a practical embodiment, module 32 is embodied as a software module 32a written in a conventional language and installed within a memory 38 of an embodiment 31a of device controller 31 whereby a processor 37 of device controller 31a can execute software 32a to perform various operations of the present invention as described in connection with the illustration of FIGS. 2 and 3.

Referring to FIGS. 1-3, those having ordinary skill in the art of the present invention will appreciate the applicability of module 11 to other forms of removable media systems (e.g., optical disk systems).

Referring to FIG. 1, those having ordinary skill in the art will appreciate alternative device embodiments of tape systems 30, such as, for example, an embodiment where each device of the tape system is allocated its own individual device controller or an embodiment employing multiple device controllers where each controller is allocated to a device having one or more drives.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

I claim:

1. A signal bearing medium tangibly embodying a program of machine-readable instructions executable by a processor to perform operations comprising:
controlling a writing of data from a host to a device including a first media mounted in a first drive; and
controlling a swap of the first drive for a second drive in response to a detection of a defect in the device,
wherein the controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

2. The signal bearing medium of claim 1, wherein the controlling of the swap of the first drive for the second drive is executed in a manner transparent to the host.

3. The signal bearing medium of claim 1, wherein the controlling of the swap of the first drive for the second drive further includes:
notifying the host of an implementation of an error recovery in response to the detection of the defect in the device.

4. The signal bearing medium of claim 1, wherein the controlling of the swap of the first drive for the second drive further includes:
controlling a dismounting of the first media from the first drive and a subsequent mounting of the first media in the second drive to thereby facilitate a writing by the second drive of any recovered first portion of the data.

5. The signal bearing medium of claim 1, wherein the controlling of the swap of the first device for the second drive further includes:
controlling a mounting of a second media in the second drive to thereby facilitate a writing of any recovered first portion of the data and any recovered second portion of the data to the second media.

6. The signal bearing medium of claim 1, wherein the controlling of the swap of the first device for the second drive further includes:
notifying the host of a successful error recovery subsequent to the writing at least one of any recovered first portion of the data and any recovered second portion of the data to the second drive.

7. The signal bearing medium of claim 1, wherein the first drive and the second drives are tape drives and the first media is a tape cartridge.

8. A device controller, comprising:
a processor; and
a memory storing instructions operable with the processor, the instructions are executed for:
controlling a writing of data from a host to a device including a first media mounted in a first drive; and
controlling a swap of the first drive for a second drive in response to a detection of a defect in the device,
wherein the controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

9. The device controller of claim 8, wherein the controlling of the swap of the first drive for the second drive is executed in a manner transparent to the host.

10. The device controller of claim 8, wherein the controlling of the swap of the first drive for the second drive further includes:
notifying the host of an implementation of an error recovery in response to the detection of the defect in the device.

11. The device controller of claim 8, wherein the controlling of the swap of the first drive for the second drive further includes:
controlling a dismounting of the first media from the first drive and a subsequent mounting of the first media in the second drive to thereby facilitate a writing by the second drive of any recovered first portion of the data.

12. The device controller of claim 8, wherein the controlling of the swap of the first device for the second drive further includes:
controlling a mounting of a second media in the second drive to thereby facilitate a writing of any recovered first portion of the data and any recovered second portion of the data to the second media.

13. The device controller of claim 8, wherein the controlling of the swap of the first device for the second drive further includes:
notifying the host of a successful error recovery subsequent to the writing at least one of any recovered first portion of the data and any recovered second portion of the data to the second drive.

14. The device controller of claim 8, wherein the first drive and the second drives are tape drives and the first media is a tape cartridge.

15. A storage subsystem, comprising:
a plurality of media;
a plurality of drives; and
a device including a device controller operatively coupled to a first drive
wherein the device controller is operable to control a writing of data from a host to a first media mounted in the first drive,
wherein the device controller is further operable to control a swap of the first drive for a second drive in response to a detection of a defect in the device, and
wherein the controlling of the swap of the first drive for the second drive includes recovering at least one of any first portion of the data buffered in the first drive and any second portion of the data recorded on the first media, and writing at least one of any recovered first portion of the data and any recovered second portion of the data to the second drive.

16. The storage subsystem of claim 15, wherein the device controller controls the swapping of the first drive for the second drive is executed in a manner transparent to the host.

17. The storage subsystem of claim 15, wherein the controlling of the swap of the first drive for the second drive by the device controller further includes:
notifying the host of an implementation of an error recovery in response to the detection of the defect in the device.

18. The storage subsystem of claim 15, wherein the controlling of the swap of the first drive for the second drive by the device controller further includes:
controlling a dismounting of the first media from the first drive and a subsequent mounting of the first media in the second drive to thereby facilitate a writing by the second drive of any recovered first portion of the data.

19. The storage subsystem of claim 15, wherein the controlling of the swap of the first device for the second drive by the device controller further includes:
controlling a mounting of a second media in the second drive to thereby facilitate a writing of any recovered first portion of the data and any recovered second portion of the data to the second media.

20. The storage subsystem of claim 15, wherein the controlling of the swap of the first device for the second drive by the device controller further includes:
notifying the host of a successful error recovery subsequent to the writing at least one of any recovered first portion of the data and any recovered second portion of the data to the second drive.

21. The storage subsystem of claim 15, wherein the first drive and the second drives are tape drives and the first media is a tape cartridge.
